(19) United States
(12) Patent Application Publication
(10) Pub. No.: US 2004/0261933 A1
(43) Pub. Date: Dec. 30, 2004

(54) Method for the adhesion of windowpanes

(75) Inventors: Manuel Buck, Gebenstorf (CH); Stefan Agerter, Bern (CH); Urs Uehlinger, Biel (CH)

Correspondence Address: BURNS DOANE SWECKER & MATHIS L L P, POST OFFICE BOX 1404, ALEXANDRIA, VA, 22313-1404, US

(73) Assignee: Sika Technology AG

(21) Appl. No.: 10/726,617

(22) Filed: Dec. 4, 2003

(30) Foreign Application Priority Data
Dec. 4, 2002 (EP) 02027129.2

(51) Int. Cl. E06B 3/00

(52) U.S. Cl. 156/108

(57) ABSTRACT

In the case of a method for the purpose of adhering windowpanes with a frame that exhibits sealing lips and in which, after establishing contact with the windowpane 1, an adhesive 6 is pressed into the hollow space 5 formed by at least sealing lip 2 and windowpane 1 through openings 4, which are arranged in frame 3, a composite article occurs after hardening. This method is particularly well suited to the production of windows and doors, especially folding windows and folding doors.

### BACKGROUND

1. Field of the Invention

The invention relates to the adhesion of windowpanes. The adhesion of windowpanes is a very important area and it is being automated to an increasing degree. In order to assure industrial production, it is important that the adhesion occur reliably and quickly.

2. Description of the Related Art

In automobile building, using single component polyurethane adhesives, for a long time windowpanes have been glued to the body in that, through the use of robots, a bead of adhesive is applied to the body, and then the windowpane is pressed onto it.

In the construction of windows, too, windowpanes are glued more and more. On the one hand, before the joining of pane and frame, the adhesive is applied to one of the partners of the joint, and then joined. This is described, for example, in EP 1 106 770. In lieu of a reactive adhesive, an adhesive tape is frequently used as well.

On the other hand, in window construction, the windowpane is often fixed to the frame by means of wedges or blocking elements and then glued by virtue of the fact that the open joint between frame and windowpane is filled up with adhesive.

EP 0 937 856 describes glued windows in the case of whose manufacture, prior to mounting, a polyurethane adhesive is applied to a limb between two double adhesive tape strips, as a bead. However, this method is suitable only for adhesives that harden slowly.

The precise setting of a windowpane, so as to assure a proper fit, is very critical, especially in the case of larger windowpanes, because lateral and vertical positioning errors can occur. Furthermore, for rapid industrial production, an adhesive with a short setting time is desired. By virtue of the fact that the adhesive is first applied to one of the two partners of the joint and the windowpane is subsequently added, the problem occurs that the adhesive comes into contact with the second partner of the joint at the end of its setting time, as a result of which adhesion problems and the absence of tight seals result. For this reason, a correction of an improper joint position is practically impossible, especially in the case of quick-setting adhesives.

Due to the aesthetic aspects, designers and architects frequently demand that the windowpane be flush with the frame or other windowpane elements. The expert knows such an arrangement by the term “flush glazing,” and it can be achieved by constructions such as those described in DE 41 12 826, for example. An adhesion of the inside of a windowpane with the frame, however, renders it necessary for the adhesive to exhibit mechanical properties of a sufficiently high degree, and good adhesion, which must be maintained in the long term, which cannot, in addition, be diminished by environmental influences.

Due to the absence of a cover provided by the portions of the frame that encompass the windowpane, the point of adhesion is visible from the outside. For this reason, it is important that the adhesion run homogeneously and that its boundaries be clean.

To surmount these difficulties, a glass ceramic layer is frequently applied to the glass in the area of adhesion. However, the use of such glass ceramic layers does render the windowpanes more costly, and thus, the windowpane composite, to a massive extent.

In the case of the customary adhesion, the adhesive is applied to the frame, in the form of a triangular bead, for example, and subsequently compressed. In the process, the height of the adhesive bead is such that it is significantly higher than the distance between the frame and the windowpane that is to be glued. Then, in the course of pressing, the excessive adhesive is displaced toward the side. In the process, the quantity of the adhesive that is applied varies markedly, particularly in the case of manual application. For this reason, in order to assure complete adhesion, a greater amount of adhesive than is theoretically necessary is used.

The use of wood as a renewable raw material for the industrial production of consumer goods and construction projects is the topic of long years of research and expertise at the Swiss College of Wood Management, S H Biel. As a traditional material, wood was supplanted to a large degree in the last century by the use of metal and plastics. Due to increasing environmental awareness and acceptance in society, however, a trend toward reconsidering the use of wood can be ascertained. However, in order to meet the higher standards of the market as well, it is necessary to distance oneself from the exclusive use of traditional wood production technology. The joining of traditional wood production technology with new technologies, such as adhesives technology, permits the development of windows of a higher standard. Thus far, wooden-framed windows have not been industrially produced on a larger scale by means of adhesive technology. As a result of the properties of the material wood, special requirements are made of the adhesive and its resistant capabilities as well.

The gluing of wood is, however, extremely critical, because long-term adhesion, particularly because of environmental influences, such as UV light and moisture, is, in many instances, inadequate, and for that reason, a long-term non-positive adhesion is called to question.

### SUMMARY

It was the task of the present invention to surmount the disadvantages of the state of the art and to provide a method for the adhesion of windowpanes with frames in which a visible aesthetically flawless adhesion occurs, which also permits rapid industrial production.

Surprisingly, within the context of a developmental project by the inventors of the firm of Sika Schweiz A G and the Swiss College of Wood Management, S H Biel, it was found, jointly, that a method according to claim 1 permits the solution of the described task.

### BRIEF DESCRIPTION OF THE DRAWINGS

In what follows, embodiments of the invention are elucidated in greater detail by virtue of the drawings. In the various figures, identical elements are given identical reference symbols. Arrows indicate the direction of media flow.

FIG. 1 shows a partial cross-section of the arrangement windowpane/sealing lip/frame prior to pressing in the adhesive.

FIG. 2 shows a partial cross-section of the arrangement windowpane/sealing lip/frame after pressing in the adhesive.

FIG. 3 shows a partial cross-section through various forms of sealing lips.

FIG. 4 shows a partial cross-section through various forms of windowpane adhesions.

FIG. 5 shows a partial cross-section through an arrangement windowpane/frame with details as to the configuration of the opening for the purpose of pressing in the adhesive.

FIG. 6 shows a transverse view of an arrangement windowpane/frame, prior to adhesion.

FIG. 7 shows a view, from above, of an arrangement windowpane/frame

a) prior to adhesion;

b) during adhesion; and

c) after adhesion.

FIG. 8 shows a partial cross-section of a folding window.

Only those elements that are critical for the immediate understanding of the invention are shown. Not depicted, for example, are the means of pressing on, the static mixing elements, the adhesive cartridge or pump.

### DETAILED DESCRIPTION OF THE EMBODIMENTS

The present invention relates to a method for adhering windowpanes 1 to a frame 3 that exhibits sealing lips 2, such that it comprises the steps:

contacting windowpane 1 with a sealing lip 2,

pressing in the adhesive 6 through at least one opening in the frame 4 into a hollow space 5 that is bounded by at least a sealing lip and windowpane,

hardening the adhesive 6.

In the present application, in its entirety, the term “windowpane” is taken to mean a flat or curved plate made of glass or a plastic that is essentially transparent. The plates at issue here may be single-layer or multi-layer plates, especially, in addition, windowpanes with films between the glass plates, as they are used as safety glass panes in automobile building, for the windshield, for example. Windowpanes made of multi-layered plates, such as insulating glass windowpanes, especially double and multiple-layer insulating glass panes, as are customary in window and door construction, are preferred.

In the present application, in its entirety, the term “frame” is taken to mean the body onto which the windowpane is glued, if necessary over parts of the sealing lip. This body can represent a structure or a partial structure of a construct or a motor vehicle. A headlight housing may be cited as an example of a partial structure of a motor vehicle. The frame can, furthermore, exhibit hinges or similar connective elements, which permit an unfolding or opening in relation to the remaining supporting structure. Folding windows or doors, or collapsible windows are examples of this embodiment form of the invention. The frame can, as a matter of principle, be constructed of any arbitrary material. In the preferred embodiments, the frame is constructed substantially of wood or lacquered wood.

A glued article results from the adhesion of the windowpane and the frame. In the sense of the invention, the term “article” is taken to mean any object that exhibits a windowpane glued to a frame. A car, a ship, a train, or a building, for example, can represent such an article.

The adhesion of the windowpane and thus, the position of the sealing lip, is located, preferably, in the region of the windowpane's edges. However, adhesions that are not located in the area of the edges are also possible. An example of such an application would be the adhesion of very large windowpanes, in which, for reasons of stability, the windowpane is reinforced by glued transverse staves.

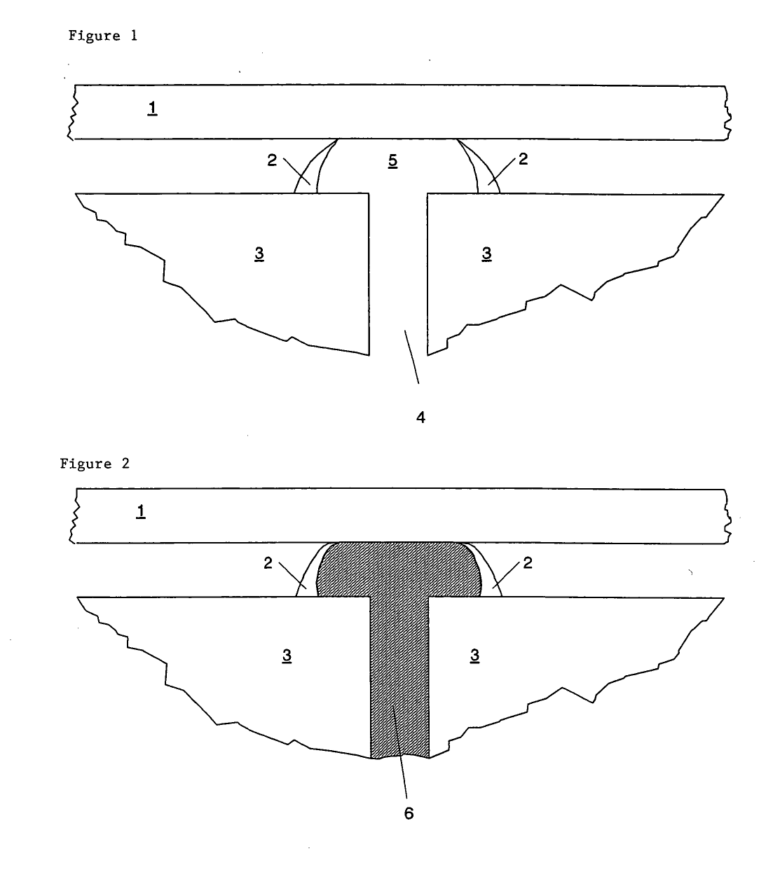

FIGS. 1 and 2 show, schematically, the arrangement windowpane 1/sealing lip 2/frame 3, before and after the application of the adhesive 6.

The sealing lips 2 are produced, preferably, of an elastic material. Preferred materials for this are rubber, EPDM or TPE. The elasticity of the sealing lips is attuned to the weight of the windowpane or to the pressure applied to press it on, respectively. The shape of the sealing lips is, to good advantage, such that the sealing lip is deformed by the impinging pressure caused by the adhesive that is pressed in, and it presses itself onto the windowpane. This is achieved, in particular, by virtue of the fact that in the cross-section to the windowpane and to the adhesion, the one sealing lip 2, at least, exhibits the hollow space 5, a concave form, which is bounded by at least sealing lip 2 and windowpane 1 in the area of the transition between sealing lip 2 and windowpane 1.

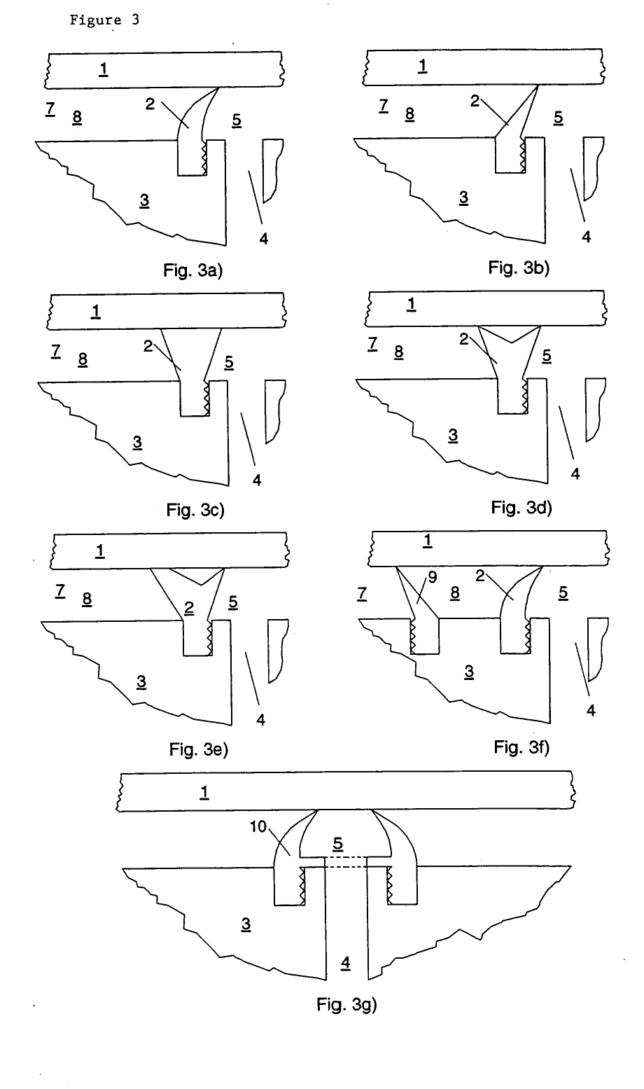

A few examples of the shape of such sealing lips are schematically displayed in FIG. 3. Combinations of these various sealing lips can be present as well. Furthermore, it is advantageous if the sealing lip closes off, in a concave manner, the external space 7 (FIG. 3c-f), which is bounded, at least, by the sealing lip and the windowpane in the area of the transition between the sealing lip and the windowpane.

This causes at least the outer side of the sealing lips, which is exposed to the potential environmental influences, to assume an additional protective function by virtue of the fact, for example, that rainwater or condensation cannot penetrate between sealing lip and glass, or into the hollow space 5, which is filled with adhesive 6. It is self-evident that this preferred sealing function, with respect to media that originate from outside, can also occur by means of a separately arranged sealing lip, or a covering strip or another means of sealing 9, as is depicted schematically, for example, in FIG. 3f. Such additional means of sealing can make direct contact with the sealing lip, which closes off the hollow space 5 that is filled with adhesive 6, or it can be separated from it by means of additional hollow spaces 8. As a matter of principle, in addition to an adhesion, which was produced in accordance with a method according to the invention, additional adhesives and/or sealants can be provided between the frame and the windowpane. These can be arranged after the conventional manner on the windowpane or the frame before the contacting of windowpane and sealing lip, or be applied by means of a joint between the frame and the windowpane that is accessible from the outside, or they can be pressed in through an additional opening that is present in the frame into a hollow space 5 that is bounded by an additional sealing lip and windowpanes after the sealing lip makes contact with the windowpane.

It is advantageous if the sealing lips also close off hollow spaces 8 in such a manner that the latter exhibit a concave form in the area of transition between sealing lip and windowpane.

If, in the figures, adjacent to a sealing lip, both 7 and 8 are indicated, this is intended to represent that either an exterior space 7 that is in contact with the environs, or a closed hollow space 8 can be present.

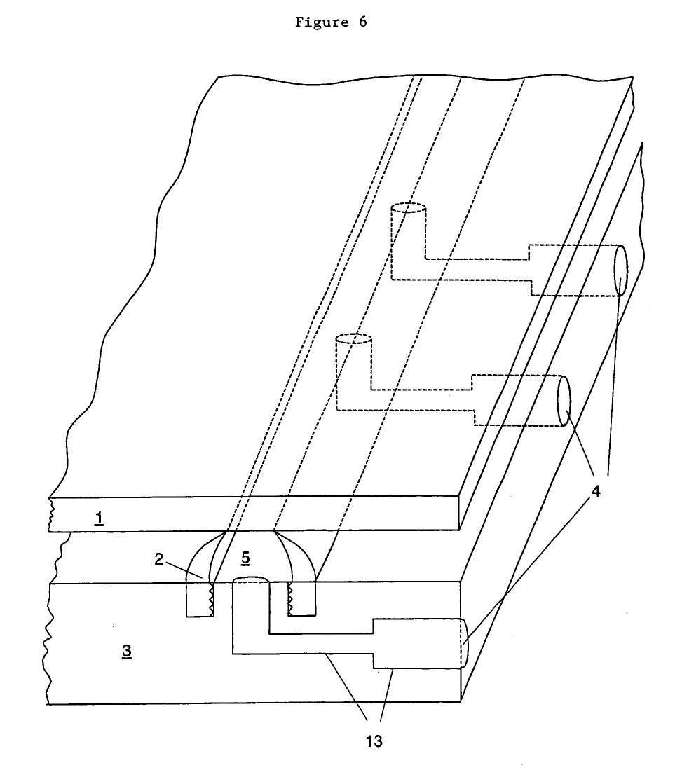

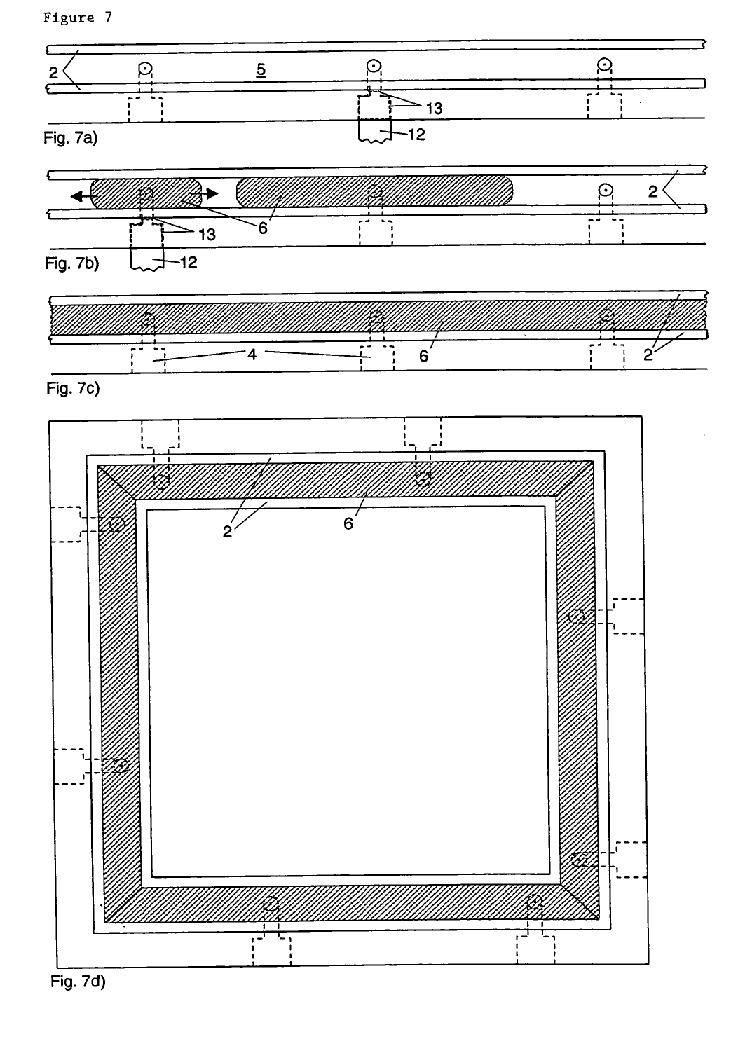

The sealing lip customarily extends in the longitudinal direction to the cross-section, as is depicted in FIGS. 1 through 6 in each case. It is advantageous if the ends of the sealing lips that face the front touch each other or are connected to each other, and by these means, a self-enclosed annular or channel-shaped hollow space 5, into which adhesive 6 is pressed, is formed. FIG. 7d shows, schematically, such an annular or channel-shaped hollow space, filled with adhesive 6.

This annular hollow space 5 runs, preferably, around the external area of the windowpane so that the entire windowpane is glued, and thus sealed, with a layer of adhesive that runs around its circumference.

Two sealing lips that run parallel to each other are preferred. The sealing lips are, to good advantage, glued to the frame or connected by means of attachment elements that engage grooves. These attachment elements can be connected to sealing lip 2, or they can represent an integrated portion of the sealing lip. The hollow space 5 for accepting the adhesive is hereby bounded by sealing lips, windowpane, and frame. It is possible, however, for the sealing lips 2 to be connected with one another and form, in cross-section, a substantially U-shaped sealing profile 10 as a special instance of sealing lips 2, whose base is connected with the frame. In this case, hollow space 5 for the acceptance of the adhesive is bounded only by the sealing lips and the windowpane, whilst openings are provided in the U-shaped profile and the frame connected with it for the admission of the adhesive (schematically represented in FIG. 3g).

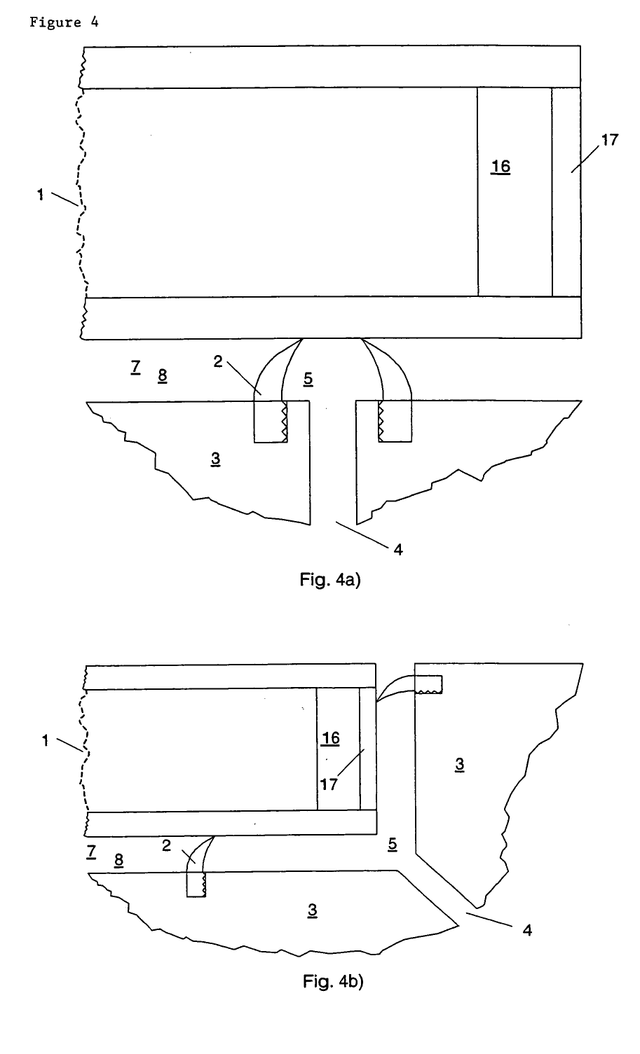

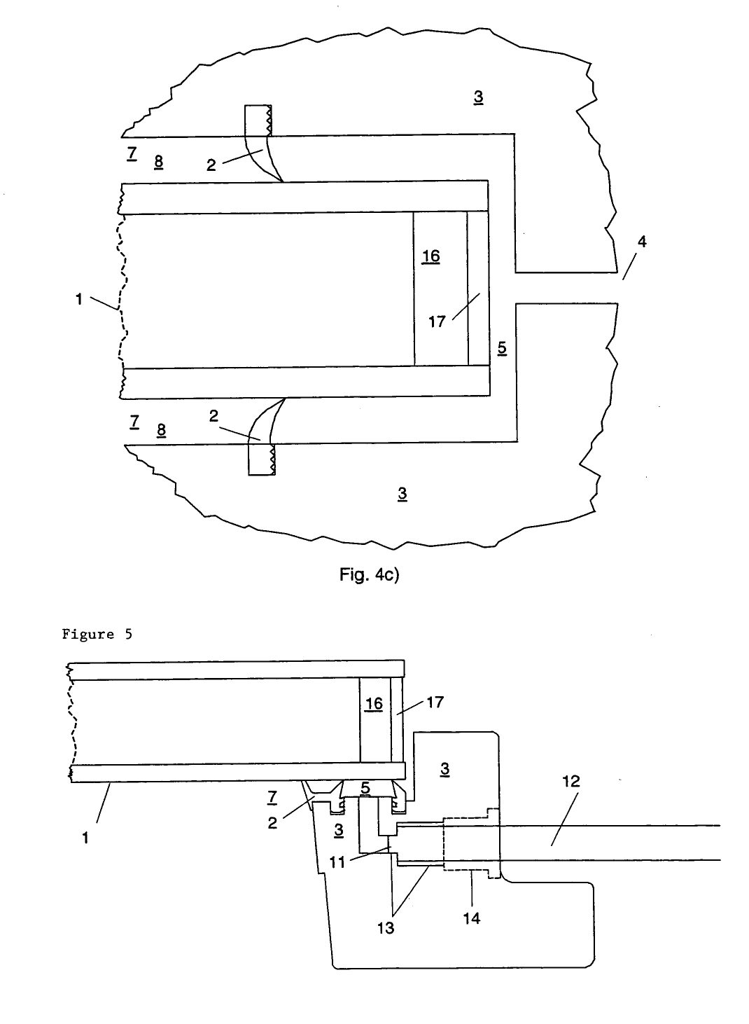

FIG. 4 show, schematically, preferred arrangements of the windowpane/sealing lip/frame. The hollow space 5 for the acceptance of adhesive 6, which is bounded, at least, by sealing lips and windowpane, can totally encompass one end of the windowpane (FIG. 4c), or be arranged on one side of the windowpane together with the front side of the windowpane (FIG. 4b), or be arranged merely on one side of a windowpane (FIG. 4a). However, the embodiment presented in FIG. 4a, in which this hollow space 5 for the acceptance of the adhesive is found on one side of the windowpane entirely, is particularly preferred.

Opening 4 can contact hollow space 5, which is bounded at least by sealing lip and windowpane, anywhere in the frame. In the process, the opening extends after the manner of a channel between hollow space 5 and an external side of the frame. This channel-like extension of the opening is preferably angled, particularly around an angle of about 90°.

It is, however, advantageous if this opening is arranged approximately centrally between the sealing lips. This is important, especially in those cases in which, by virtue of the geometry, the lips are far removed from each other.

It has proven to be particularly suitable if the sealing lips are drawn into milled grooves in the frame.

The windowpane 1 is brought into contact with the sealing lip 2 before the adhesive 6 is pressed in. This occurs to good advantage by laying the windowpane horizontally onto the frame, which is supported, for example, on a table. Depending upon the size, or weight of the windowpane, respectively, and the elasticity of the sealing lip, a sufficiently high compressive force is present so that the sealing lip seals the adhesive, which is subsequently pressed on, without further means of applying further pressure. It is, however, also entirely possible that prior to pressing in adhesive, the compressive force applied to the windowpane is elevated by the application of a vacuum. In addition to, or in lieu of the vacuum, other means of applying pressure, such as, for example, clamping, cramping, or hydraulic means of applying pressure, can be applied. For this reason, the adhesion of the windowpane is not limited to a horizontal orientation. It is also possible to apply the adhesion of the windowpane directly to a motor vehicle or building in an inclined or vertical orientation. For the industrial production of door and window panels, however, the horizontal orientation is preferred for the adhesion.

As adhesive 6, as a matter of principle, any adhesive is suitable that exhibits sufficiently good properties of flow so that it can be pressed into hollow space 5 under pressure, and a setting time that is, on the one hand, at least so long that the adhesive can fill the entire hollow space 5 that is bounded by the windowpane, the sealing lip, and the frame, if necessary, and is, on the other hand, so short that the cross-linking, and thus, the build-up of the adhesive's hardness, can occur as quickly as possible. This has as a consequence that the glued article can be dealt with as quickly as possible after the adhesion. It was found that, depending upon the size of the windowpane and the number of pressing-in openings, an optimal setting time for the industrial adhesion of windowpanes ranges between 1 and 20 minutes, especially between 1 and 10 minutes, preferably between 1 and 5 minutes. Thus, for example, dual component adhesives based upon epoxides, polyisocyanates, or (meth)acrylates, are suitable adhesives. Rapid hardening of the adhesives is also possible by means of the effects of heat or light. Those dual-component adhesives that contain at least one (meth)acrylate and can be hardened at room temperature by radicals, preferably those originating from peroxides, have proven to be particularly well suited. A crucial factor in the selection of the adhesive is good adhesion to the windowpane, the sealing lip, and, if necessary, to the frame. A further aspect in the selection of the adhesive is its UV stability. The adhesive is exposed to UV radiation, which can reach the adhesion through the windowpane. For this reason, in the case of an adhesive that is unstable under UV, either a sufficiently large covering must be provided by means of the frame or a covering strip, or the use of a ceramic coating is necessary. When an adhesive that is UV-stable is used, by contrast, therefore, even in the absence of a cover, a windowpane without a glass ceramic layer can be used. Thus, an adhesion directly on the windowpane, without the presence of any coating, is rendered possible. Due to the various materials and their expansive properties with respect to heat and moisture, a rigid adhesive is not suitable. The adhesive must, therefore, possess a certain degree of elasticity in order to be able to absorb those tensions that arise as a result of environmental influences.

Because it is possible, with (meth)acrylates, to formulate such UV-resistant, rapidly elastic, and readily adhering adhesives, adhesives based upon acrylates and/or methacrylates are preferred.

The adhesion process is illustrated in FIGS. 5 through 7.

After the windowpanes make contact with the sealing lip, the pressing in of the adhesive takes place. In this process, the adhesive is introduced through at least one opening in the frame that is provided for that purpose, into the hollow space 5, which is bounded at the least, by the windowpane and the sealing lip. The minimum of one opening is preferably designed in such a way that it can accommodate the egress end 11 of a static mixer 12 and is sealed off by the latter.

Common, commercially available static mixers exhibit at their egress end 11, a substantially conic or graduated form. In this case, it is advantageous if the form of the opening that is present in the frame can be achieved by at least two concentric bore holes 13 of varying diameter that are adapted to the static mixer. Such openings can also be made using a variable hole cutter. Concentric variable boring facilitates, in addition, the introduction of the static mixer to the opening in such a manner that the fit is precise.

After the removal of the static mixer, this opening, which is configured in this manner, can also serve to accept any adhesive that might escape from hollow space 5, thus preventing an escape of the adhesive to the external area of the frame, so that soiling and thus, aesthetic problems generally, can be prevented with respect to visible portions of the frame.

The boreholes or rather, the openings, are arranged to good advantage in such a manner that on the finished article, they are not visible from the outside, or they can be easily hidden. It proved to be particularly suitable to arrange the openings in the fitting groove 14 of the frame.

In order to assure an adhesion that is as free as possible of errors and air bubbles, the air that is present in hollow space 5, which is bounded, at least, by a sealing lip and a frame, escapes to good advantage from this space, when the adhesive is pressed in. This can occur through openings 4 for the pressing in of adhesive, which are not yet filled with adhesive, or through any escape openings that might be present in the frame or the sealing lips, by way of slight areas where tightness between the sealing lip and the windowpane is lacking, or, in the case of a porous frame material, such as wood, for example, through these pores.

For the inward pressing, common, commercially available manually, hydraulically, or pneumatically operated pistols for dual component cartridges, or, in the case of larger applications, dual-component pumps, have proven to be suitable. It is advantageous if at least 2 openings 4 are present for the entry of the adhesive.

It has been shown, furthermore, that the procedure described in the following and schematically presented in FIG. 7 leads to very good results. After establishing contact between windowpane 1 and sealing lip 2, the adhesive 6 is initially pressed in through the first opening 4 by means of static mixer 12 and sealed off by means of bore holes 13. As soon as the adhesive has run through about half the distance as far as the next opening, the static mixer is removed from the first opening, connected to the next opening and through the latter, begins to press in adhesive again until the adhesive has spread so far that it has flowed together with the adhesive that was pressed in previously and has run through approximately half the distance to the next opening. This procedure is continued in this way until finally, the entire hollow space 5 is filled up with adhesive. Under certain circumstances, however, it can also be worthwhile to press adhesive 6 in through several openings 4 into hollow space 5 simultaneously.

Filling the entire hollow space is taken to mean that the hollow space is essentially filled; that means that in smaller areas, such as, for example, on edges or corners, it is entirely possible that gaps and hollow spaces are present. Furthermore, the possibility should not be precluded that rather small air bubbles or gaps are present in the adhesive. If significantly fewer gaps, which are caused by air bubbles, are present, this means, in addition, that in the calculation of the composite's resistance capabilities, the safety additives can be reduced, which can lead to financial advantages for the user.

If the frame exhibits more than one opening for pressing in the adhesive, air, which is found in the hollow space that is bounded by at least the seal lips and the windowpane, can escape through the openings not yet filled with adhesive. It can, however, be advantageous that additional escape openings, such as fine bore holes, slits, gaps or the like, be present in the frame or seal lips.

It has been shown that the optimal distance between two openings 4 for the purpose of pressing in the adhesive is between 0.2 and 0.5 meters. The rate of the adhesive's introduction is to be selected in such a manner that the adhesive fills the hollow space at a constant rate.

For the method according to the invention, the adhesive must not flow too thinly, otherwise it can escape very easily again, through the openings 4, from the hollow space 5, which is filled with adhesive. If it is too viscous, however, no meaningful introduction of the adhesive into the hollow space 5 can occur, and, in particular, no aesthetically flawless adhesion can be accomplished. It has been shown that the best results can be achieved with a filled, firm adhesive. In addition, it is important for the adhesion that the application be attuned to the viscosity of the adhesive used. To this end, the parameters such as number of pressing in openings, distance between these entry openings, the cross-section geometry of the adhesion, the surface characteristics of the frame and seal, and the pressure applied for pressing in, must be considered. Using the described method assures that homogeneous filling of the entire hollow space with adhesive can occur, without, in addition, visible inclusions of air or overflows of adhesive, and by these means, an aesthetically flawless visible adhesion can be achieved.

Since the adhesive in the method according to the invention is introduced to a hollow space that is bounded, at least, by a sealing lip and a windowpane, the adhesive joint is geometrically precisely defined. Thus, the adhesive can be applied to the desired point in a concerted and visually controllable manner and indeed, in such a manner that the required quantity of adhesive is used in as precise a manner as possible. Because the geometry of the adhesion is precisely defined by the hollow space, the consistency tolerances must be set lower, which also, likewise, leads to a smaller consumption of adhesive, and nevertheless to a reliable and tight adhesion, quite the contrary to the customary adhesion of windowpanes where, on the one hand, the width of the adhesive beads can vary markedly locally, and the excess adhesive is displaced in an uncontrolled manner as a result of being pressed.

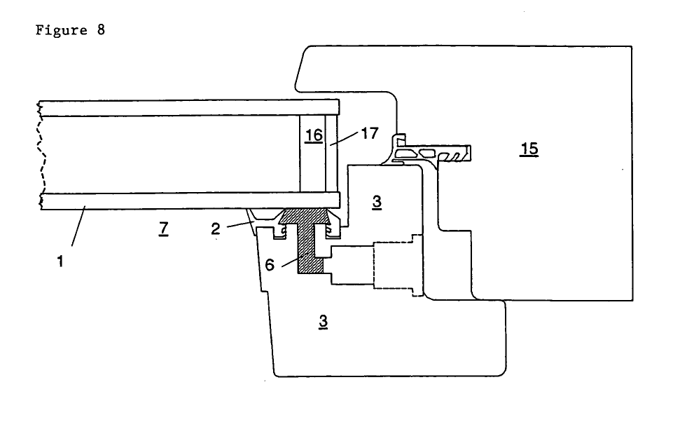

The method according to the invention has been shown to be particularly well suited for the production of windows and doors, especially of folding windows or folding doors. FIG. 8 represents, schematically, a folding window in which an insulating glass pane is jointed to a frame 3 by means of adhesive 6. The frame, for its part, is connected to a supporting structure 15 by way of connective elements, such as hinges, which are not shown.

The method described permits the production of articles both with covering frames and with frames that do not provide any cover. “Flush glazing” embodiments, in which the frame does not provide cover, and in which the adhesive is found only on the interior of the windowpane, are particularly preferred.

List of Reference Symbols:

1 Windowpane

2 Sealing lip

3 Frame

4 Opening for pressing in the adhesive

5 Hollow space, bounded at least by windowpane 1 and sealing lip 2

6 Adhesive

7 External space

8 Additional hollow space

9 Other means of sealing

10 Essentially U-shaped sealing profile

11 Egress end of a static mixer

12 Static mixer

13 Bore holes

14 Fitting groove of the frame

15 Supporting structure

16 Spacer

17 Insulating glass seal

1. A method for the adhesion of windowpanes (1) using a frame (3) that exhibits sealing lips (2) comprising the steps:
contacting the windowpane (1) with sealing lip (2);
pressing in the adhesive (6) through at least one opening (4) in the frame into a hollow space (5) that is bounded by at least a sealing lip and a windowpane; and
hardening the adhesive (6).

2. The method according to claim 1, characterized in that the ends of the sealing lip (2) that face the front touch each other or are connected and form an enclosed annular or channel-shaped hollow space (5), into which adhesive (6) is pressed.

3. The method according to claim 1, characterized in that two sealing lips bound the hollow space (5).

4. The method according to claim 3, characterized in that the two sealing lips are connected with each other and represent an essentially U-shaped sealing profile (10).

5. The method according to claim 1, characterized in that the adhesive (6) is pressed into the hollow space (5) through at least 2 openings (4) in the frame.

6. The method according to claim 1, characterized in that in addition, at least one egress opening is present in the frame (3) or sealing lip (2).

7. The method according to claim 1, characterized in that the sealing lip (2) is produced of an elastic material and is deformed by means of impinging pressure caused by the adhesive (6) that is pressed in, and presses itself onto the windowpane (1).

8. The method according to claim 1, characterized in that in the cross-section to the windowpane and to the adhesion, the single sealing lip, at least, exhibits the hollow space (5) in a concave form, which is bounded by at least one sealing lip and windowpane, in the area of the transition between the sealing lip (2) and the windowpane (1).

9. The method according to claim 1, characterized in that prior to the pressing in of the adhesive, the windowpane is pressed upon using means of applying pressure, or by the application of a vacuum.

10. The method according to claim 1, characterized in that the hollow space (5), which is bounded by at least a sealing lip and a windowpane, is essentially completely filled with adhesive (6).

11. The method according to claim 1, characterized in that the adhesive's setting time exhibits between 1 and 20 minutes, especially between 1 and 10 minutes, preferably between 1 and 5 minutes.

12. The method according to claim 1, characterized in that the adhesive contains at least one (meth)acrylate.

13. The method according to claim 1, characterized in that the adhesive is filled and firm.

14. The method according to claim 1, characterized in that the frame is constructed essentially of wood or lacquered wood.

15. The method according to claim 1, characterized in that the windowpane is an insulating glass pane.

16. The method according to claim 1, characterized in that the one opening (4), at least, through which the adhesive (6) is pressed in, is configured so that it accommodates the egress end (11) of a static mixer 12 and is sealed off by the latter.

17. The method according to claim 16, characterized in that the one opening (4), at least, through which the adhesive is pressed, is so configured that it is produced by means of at least two concentric bore holes (13) of differing diameter.

18. An article characterized in that it is produced by means of the method according to claim 1.

19. The article according to claim 18, characterized in that the article is a window or a door, including a folding window or a folding door.

20. The article according to claim 18, characterized in that the opening through which the adhesive is pressed is arranged in the fitting groove (14) of the frame.

21. An adhesive for the purpose of producing an article according to claim 18, characterized in that the adhesive is a dual component (meth)acrylate adhesive.
